(19) United States
(12) Patent Application Publication
(10) Pub. No.: US 2016/0241576 A1
(43) Pub. Date: Aug. 18, 2016

(54) DETECTION OF ANOMALOUS NETWORK ACTIVITY

(71) Applicant: CANON KABUSHIKI KAISHA, Tokyo (JP)

(72) Inventors: Hari Rathod, Mission Viejo, CA (US); Allison Bajo, Carson, CA (US); Samuel Schrader, Irvine, CA (US)

(21) Appl. No.: 14/621,760

(22) Filed: Feb. 13, 2015

(51) Int. Cl. H04L 29/06

(52) U.S. Cl. CPC H04L 63/1425

(57) ABSTRACT

Access to web services is managed. Metrics associated with accesses to a service are collected, and the metrics include activities associated with a user. A profile associated with the user is generated and updated. One or more metrics of an incoming access request to the service are compared against the profile using a statistical measure and a corresponding threshold for detecting an anomaly. The threshold is determined based on associations between a distribution of the metrics of the profile and a subset of other profile metric distributions. There is a determination of whether the incoming access request is an anomaly based on the comparison.

### FIELD

The present disclosure relates to detection of anomalous network activity, and more particularly relates to detecting suspicious or unauthorized activity pertaining to web services on a network.

### BACKGROUND

In the field of network security, it is common to perform some type of anomaly detection regarding accesses to services on the network.

One approach previously considered involves “signature-based” intrusion detection and prevention systems. These systems rely on identifying suspicious or malicious attack patterns known as signatures. For example, a signature-based system might monitor packets on the network and compare them against a database of signatures or attributes from known malicious threats. Other approaches restrict access by denying access to intruders without valid user name/password credentials.

### SUMMARY

One difficulty with signature-based approaches is that they rely on signatures of the attack to detect attacks. Thus, the network can be vulnerable to attacks which do not match known attack signatures. For example, attackers can learn the known attack signatures and simply change their tactics to bypass the security system. Meanwhile, systems which rely on user names and passwords are vulnerable because of the tendency for users to provide the same name and password across multiple accounts or sites. As such, if one account is compromised, various other accounts will be vulnerable to the same type of attack.

The foregoing situation is addressed by using per-user statistical measures to compare metrics of an incoming access request against a metrics associated with a user's previous accesses, and determining whether the incoming access request is an anomaly based on the comparison.

Thus, an example embodiment described herein concerns managing access to web services. Metrics associated with accesses to a service are collected, and include activities associated with a user. A profile associated with the user is generated and updated. One or more metrics of an incoming access request to the service are compared against the profile using a statistical measure and a corresponding threshold for detecting an anomaly. The threshold is determined based on associations between a distribution of the metrics of the profile and a subset of other profile metric distributions. There is a determination of whether the incoming access request is an anomaly based on the comparison.

By using a statistical measure to compare metrics of an incoming access request against a metrics associated with a user's previous accesses, it is ordinarily possible to detect suspicious activity without relying on pre-determined attack signatures, and in a manner in which any compromise is limited to a single user account.

In one example aspect, the threshold comprises a predetermined statistical variation based on the statistical measure, and the incoming access request is determined to be an anomaly if one or more of the metrics differ from the profile by greater or less than the threshold.

In another example aspect, the threshold comprises a dynamically determined statistical variation based on the statistical measure, and the incoming access request is determined to be an anomaly if one or more of the metrics differ from the profile by greater or less than the threshold.

In still another example aspect, the threshold for detecting an anomaly based on the statistical measure is modified based on a distribution of metrics in the profile. By modifying the threshold in accordance with a distribution of the metrics, it is ordinarily possible to dynamically adjust tolerances to be closer to that of a group representing past usage, for accesses which might otherwise, in isolation, be treated differently. For example, the group might be an acceptable or favored group (e.g., an engineering group which commonly downloads more data than the rest of the company), or might be a group with negative associations (e.g., a group with previous suspicious activity or policy violations).

In one example aspect, the threshold for detecting an anomaly based on the statistical measure is modified based on comparison of the distribution of metrics in the profile against a group profile representing a subset of past usage. For example, the distribution of metrics is compared against the group profile using a p-value of a T-test.

In another example aspect, the statistical measure used in the comparison is a z-score. In another example aspect, the statistical measure used in the comparison is a modified z-score using a median absolute deviation (MAD).

In another example aspect, a respective p-value of the T-test is calculated for (a) the metrics of the incoming access request and (b) the metrics in the other distribution, and the p-values are both compared to the threshold.

In yet another example aspect, multiple profiles are associated with a user, and each of the profiles is compared against the incoming access request. In still another example aspect, the multiple profiles include at least two of a global profile, a profile based on geographic information, a company profile, an IP profile, a user agent profile, and a user profile.

In yet another example aspect, if the incoming access request is determined to be an anomaly, the incoming access request is denied. In another example aspect, if the incoming access request is determined to be an anomaly, the incoming access request is allowed, with future requests from the associated user being subject to increased security.

In one example aspect, the profile is dynamically updated in real-time or pseudo-real-time based on the accesses. In another example aspect, the profile is updated after a set time period. In still another example aspect, the profile is updated after a predetermined amount of data has been collected.

In yet another example aspect, the metrics include one or more of IP address, geographic information, date and time of visit, uniform resource identifier (URI) access patterns, download patterns, browser type, operating system, operating system version, browser version, user agent, web-related metrics computed via an analytical engine or a prediction engine, and a device used to access.

In one example aspect, the threshold for detecting an anomaly based on the statistical measure is modified based on a distribution of one metric in the profile. In another example aspect, the threshold for detecting an anomaly based on the statistical measure is modified based on a distribution of a subset of metrics in the profile. In still another example aspect, the threshold for detecting an anomaly based on the statistical measure is modified based on a distribution of all metrics in the profile.

In another example aspect, a period of time for collecting metrics associated with accesses is changed in accordance with the metrics collected. In yet another aspect, a period of time for collecting metrics associated with accesses is changed in accordance with a user selection.

This brief summary has been provided so that the nature of this disclosure may be understood quickly. A more complete understanding can be obtained by reference to the following detailed description and to the attached drawings.

### BRIEF DESCRIPTION OF THE DRAWINGS

FIG. 1 is a representative view of computing equipment relevant to one example embodiment.

FIG. 2 is a detailed block diagram depicting the internal architecture of each of the computers shown in FIG. 1 according to an example embodiment.

FIG. 3 illustrates an access management module according to an example embodiment.

FIG. 4 is a flow diagram for explaining access management according to an example embodiment.

FIGS. 5A to 5C are views for explaining statistical measures according to an example embodiment.

### DETAILED DESCRIPTION

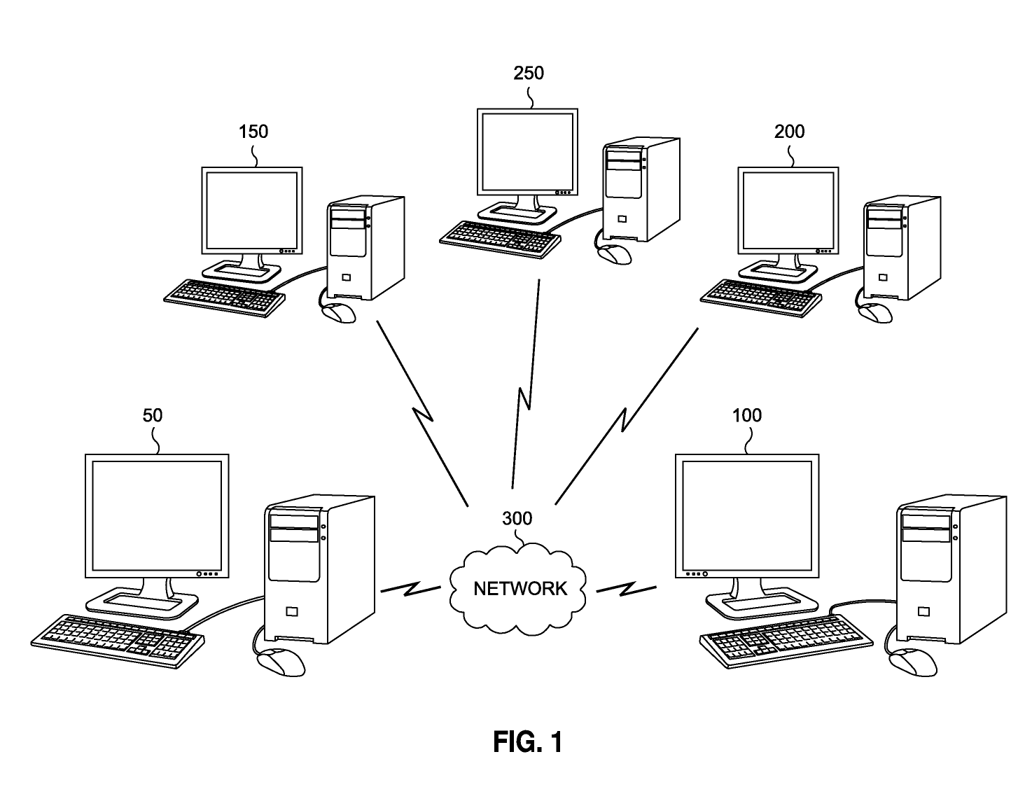

As shown in FIG. 1, computers 50, 100, 150, 200 and 250 are computers connected across a network. While five computers are shown in FIG. 1 for purposes of simplicity, it should be understood that the number of computers and/or devices on the network may be any number. Moreover, while FIG. 1 depicts a computers 50, 100, 150, 200 and 250 as desktop computers, it should be understood that computing equipment or devices for practicing aspects of the present disclosure can be implemented in a variety of embodiments, such as a laptop, mobile phone, ultra-mobile computer, portable media player, game console, personal device assistant (PDA), netbook, or set-top box, among many others.

Each of computers 50, 100, 150, 200 and 250 generally comprise a programmable general purpose personal computer having an operating system, such as Microsoft® Windows® or Apple® Mac OS® or LINUX, and which is programmed as described below so as to perform particular functions and, in effect, become a special purpose computer when performing these functions.

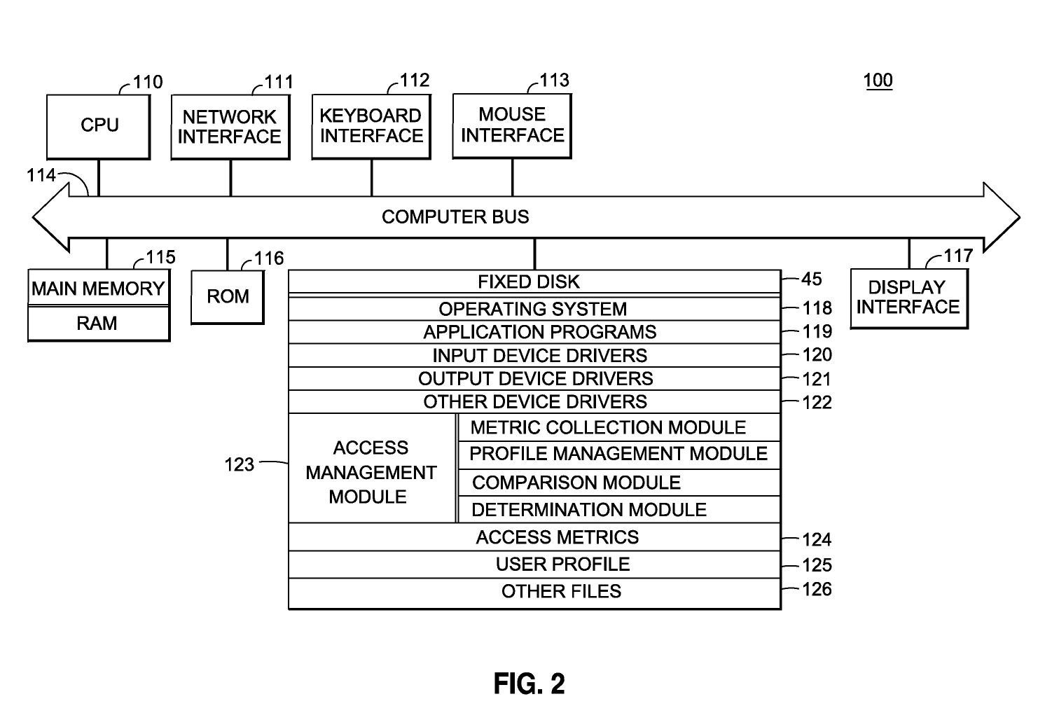

Each of computers 50, 100, 150, 200 and 250 includes computer-readable memory media, such as fixed disk 45 (shown in FIG. 2), which is constructed to store computer-readable information, such as computer-executable process steps or a computer-executable program for causing the computer to perform a method for managing access to web services, as described more fully below.

Network 300 transmits data between computers 50, 100, 150, 200 and 250. The implementation, scale and hardware of network 300 may vary according to different embodiments. Thus, for example, network 300 could be the Internet, a Local Area Network (LAN), Wide Area Network (WAN), Metropolitan Area Network (MAN), or Personal Area Network (PAN), among others. Network 300 can be wired or wireless, and can be implemented, for example, as an Optical fiber, Ethernet, or Wireless LAN network. In addition, the network topology of network 300 may vary.

FIG. 2 is a detailed block diagram depicting an example of the internal architecture of computer 100 shown in FIG. 1 according to an example embodiment. For purposes of conciseness, only the internal architecture of computer 100 is described below, but it should be understood that other computers 50, 150, 200 and 250 or other devices may include similar components, albeit perhaps with differing capabilities.

As shown in FIG. 2, computer 100 includes central processing unit (CPU) 110 which interfaces with computer bus 114. Also interfacing with computer bus 114 are fixed disk 45 (e.g., a hard disk or other nonvolatile storage medium), network interface 111 for accessing other devices across network 300, keyboard interface 112, mouse interface 113, random access memory (RAM) 115 for use as a main run-time transient memory, read only memory (ROM) 116, and display interface 117 for a display screen or other output.

RAM 115 interfaces with computer bus 114 so as to provide information stored in RAM 115 to CPU 110 during execution of the instructions in software programs, such as an operating system, application programs, and device drivers. More specifically, CPU 110 first loads computer-executable process steps from fixed disk 45, or another storage device into a region of RAM 115. CPU 110 can then execute the stored process steps from RAM 115 in order to execute the loaded computer-executable process steps. Data, such as messages received on network 300, or other information, can be stored in RAM 115 so that the data can be accessed by CPU 110 during the execution of the computer-executable software programs, to the extent that such software programs have a need to access and/or modify the data.

As also shown in FIG. 2, fixed disk 45 contains computer-executable process steps for operating system 118, and application programs 119, such as display programs. Fixed disk 45 also contains computer-executable process steps for device drivers for software interface to devices, such as input device drivers 120, output device drivers 121, and other device drivers 122. Access metrics 124 include metrics associated with one or more accesses to a service, such as IP address, date and time of access, and so on. User profile 125 comprises a profile corresponding to a user's past access patterns. Other files 126 are available for output to output devices and for manipulation by application programs.

Access management module 123 comprises computer-executable process steps for managing access to web services, and generally comprises a metric collection module, a profile management module, a comparison module, and a determination module. More specifically, access management module 123 is configured to use a statistical measure to compare metrics of an incoming access request against a metrics associated with previous accesses, and to determine whether the incoming access request is an anomaly based on the comparison. These processes will be described in more detail below.

The computer-executable process steps for access management module 123 may be configured as part of operating system 119, as part of an output device driver, such as a router driver, or as a stand-alone application program. Access management module 123 may also be configured as a plug-in or dynamic link library (DLL) to the operating system, device driver or application program. It can be appreciated that the present disclosure is not limited to these embodiments and that the disclosed modules may be used in other environments.

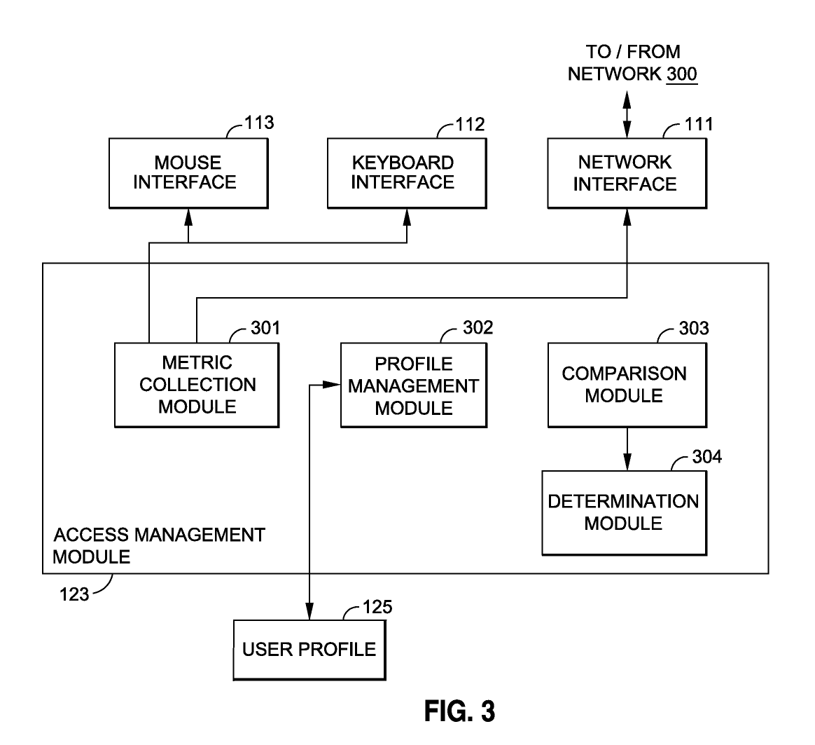

FIG. 3 illustrates an access management module 123 according to an example embodiment.

In particular, FIG. 3 illustrates an example architecture of access management module 123 in which the sub-modules of access management module 123 are included in fixed disk 45. Each of the sub-modules are computer-executable software code or process steps executable by a processor, such as CPU 110, and are stored on a computer-readable storage medium, such as fixed disk 45 or RAM 115. More or less modules may be used, and other architectures are possible.

As shown in FIG. 3, access management module 123 includes metric collection module 301 for collecting metrics associated with accesses to a service. The metrics include activities associated with a user. To that end, metric collection module 301 communicates with mouse interface 113 and keyboard interface 112, as well as network interface 111 which reaches other computers on network 300 (e.g., computers 50, 150, 200 and 250). Access management module 123 also includes profile management module 302 for generating and updating a profile associated with the user. Thus, profile management module 302 communicates with user profile 125 stored on, e.g., fixed disk 45. Access management module 123 further includes comparison module 303 for comparing one or more metrics of an incoming access request to the service against the profile using a statistical measure and a corresponding threshold for detecting an anomaly. Comparison module 303 communicates with determination module 304, which is for determining whether the incoming access request is an anomaly based on the comparison.

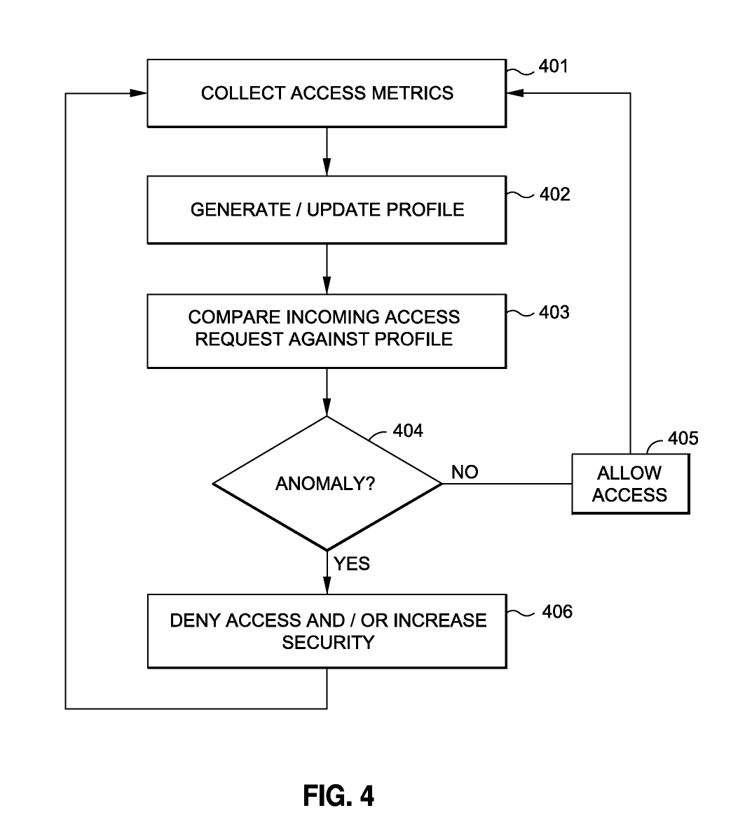

FIG. 4 is a flow diagram for explaining access management according to an example embodiment. While the steps of FIG. 4 are illustrated in sequence for purposes of simplicity, it should be understood that one or more of the steps may be occurring continuously or concurrently with other steps, and that in some cases the order of steps might change.

Briefly, in FIG. 4, metrics associated with accesses to a service are collected, and include activities associated with a user. A profile associated with the user is generated and updated. One or more metrics of an incoming access request to the service are compared against the profile using a statistical measure and a corresponding threshold for detecting an anomaly. The threshold is determined based on associations between a distribution of the metrics of the profile and a subset of other profile metric distributions. There is a determination of whether the incoming access request is an anomaly based on the comparison.

In more detail, in step 401, metrics associated with accesses to a service are collected. In one embodiment, these metrics are collected in the background, i.e., without any notification to the user. In particular, when a user (or user's computer) accesses a web service (such as a website), various metrics are collected associated with the visit. Example metrics may include values (like min, max, mean, variance and median values) of, for example, one or more of: number of hits, unique URI's visited, total number of bytes downloaded, duration of the visit, gap between visits, of IP address, geographic information, date and time of visit, uniform resource identifier (URI) access patterns, download patterns, browser type, operating system, operating system version, browser version, user agent (a software agent acting on behalf of a user), web-related metrics computed via an analytical engine or a prediction engine, a device used to access, etc.

In that regard, a period of time for collecting metrics associated with accesses can be automatically changed in accordance with the metrics collected. Put another way, a sliding or changing time window can be provided based on the nature of the metrics. For example, if a user ordinarily only accesses a site or service once a week, it is more helpful to use a longer time window so as to collect sufficient data. As an additional benefit, such considerations also might help to capture and filter out bots or other attackers which attempt to access a service at fixed time intervals.

The time window for collecting metrics might also be modified based on means, medians, etc. of statistics of user behavior, such as to account for a mean access time. Thus, the time window might for collecting metrics also vary based on how often a user requests a particular webpage, particular content or like. For example, while a user might ordinarily access a specific image once or twice during each visit to a service, an attacker might rapidly request the same content multiple times. Accordingly, in this case, the period of time might be shortened to capture this behavior.

On the other hand, a period of time for collecting metrics associated with accesses can also be changed in accordance with a user selection, e.g., a user selecting 3 months. For example, an initial user configuration of the period of time might initialize the system in order to begin collecting metrics, even if the period of time is subsequently set to change automatically as discussed above. A user may also set or select rules for automatically changing the time window, based on preference or in accordance with collected metrics as discussed above.

In step 402, a per-user profile is generated and/or updated based on the collected metrics. In particular, the collected metrics can be used to generate and update a profile corresponding to the user and/or user computer in real-time or pseudo-real-time. Thus, the user profile is continuously built based on contextual information associated with every visit of all users in the system. Accordingly, the profile can be dynamically updated in real-time or pseudo-real-time based on the accesses.

Nevertheless, real-time collection of metrics is not a necessity or a requirement. In particular, it is sometimes practical to update all profiles in a batch every arbitrary time period, or to learn user behavior and apply results when an adequate amount of data is collected, so as to have sufficient evidence for a course of action, rather than enforcing access based on a few specific occurrences which may be part of a much more general allowable case. Thus, in one example, the profile may be updated after a set time period (e.g., one month). In still another example, the profile may be updated after a predetermined amount of data has been collected (e.g., 75 accesses).

An example of data stored in a user profile is shown below in Table 1. Naturally, it should be understood that this is merely an example, and that more, less or different data and metrics may be used.

TABLE 1
Example data for user profile

| | | | | | | |
|---|---|---|---|---|---|---|
| Name | Minimum | Maximum | Mean | Median | z-score | P-Value |

| | |
|---|---|
| 1 | First visit time of the day |
| 2 | Last visit time of the day |
| 3 | Duration of each visit |
| 4 | Gap between visits |
| 5 | Total number of IP Addresses |
| | associated with user account |
| 6 | Distance between consecutive |
| | IP Addresses |
| 7 | Speed of travel between |
| | consecutive IP Addresses |
| 8 | Number of requests per session |
| 9 | Total Bytes downloaded |
| 10 | Number of URI's per session |
| 11 | Number of Devices |
| 12 | Number of Operating systems |
| 13 | Number of Browser Agents |

In one embodiment, multiple profiles are associated with a user, and each of the profiles is compared against the incoming access request. For example, the multiple profiles might include at least two of a global profile, a profile based on geographic information, a company profile, an IP profile, a user agent profile, and a user profile.

In step 403, the incoming access request is compared against the profile(s) using a statistical measure.

The determination can be made by comparing the metrics of the incoming access request to a threshold, which may be determined statistically, such as the number of standard deviations from the mean of corresponding metrics in the profile (e.g,. two standard deviations from the mean), i.e., the z-score. In another example, the statistical measure used in the comparison is a modified z-score using a median absolute deviation (MAD).

Thus, if the distribution for a user's accesses is known (and enough data has been gathered to be reasonably confident of this), the probability that the access is normal usage can be statistically determined with in a tolerance. In that regard, assumptions about the distribution can be made, but distribution's characteristics are statistically determined and used to enforce the result. For example, the probability can be thresholded against a predetermined, learned, or dynamic threshold value. The threshold can, in turn, be determined based on associations between a distribution of the metrics of the profile and a subset of other profile metric distributions. For example, a profile of user accesses might initially be matched to a “normal usage” group for a company, or to a “high usage” group which, e.g., requests more data and accesses more frequently, with the corresponding threshold for anomalous usage being based on those groups.

In addition, the threshold for detecting an anomaly based on the statistical measure can be modified based on a distribution of metrics in the profile. Specifically, the threshold can be modified in order to account for accesses which might fit other profiles for, e.g., common behavior for a particular group. Put another way, if the distribution of metrics in the access is close to that of a group profile as determined by the p-value of a T-test (discussed below), the threshold can be adjusted to be closer to the threshold of that group. The group might be an acceptable or favored group (e.g., an engineering group which commonly downloads more data than the rest of the company), or might be a group with negative associations (e.g., a group with previous suspicious activity or policy violations). Accordingly, by modifying the threshold in this manner, it is ordinarily possible to dynamically account for behavior which might, in isolation, be determined to be an anomaly, as well to update the threshold for better fit with upcoming accesses.

As a general example, a user might make accesses to a service over time. A z-score can be computed based on one or more metrics such as geolocation, access time, etc., and the z-score indicates how “unlikely” the current access is compared to past behavior, for that user, for that metric. At the same time, the distribution of one or more accesses for the current metric can be compared to a group or set of profiles (good or bad), such as profiles for different groups in a company, etc., to get a confidence score as to the similarity of the access to the groups. If the z-score for this access is far away (i.e., a far distance) from a currently acceptable value (i.e., the access metrics appear very different from common accesses for this user) , but the p-value indicates that this supposedly anomalous activity is close to that of an allowed group, the tolerance or threshold of the z-score (or the z-score itself) can be adjusted to allow more of the current type of behavior. Of course, if the distribution of metrics for the access is closer to a “negative” group, the tolerance or threshold of the z-score (or the z-score itself) can be adjusted to be stricter.

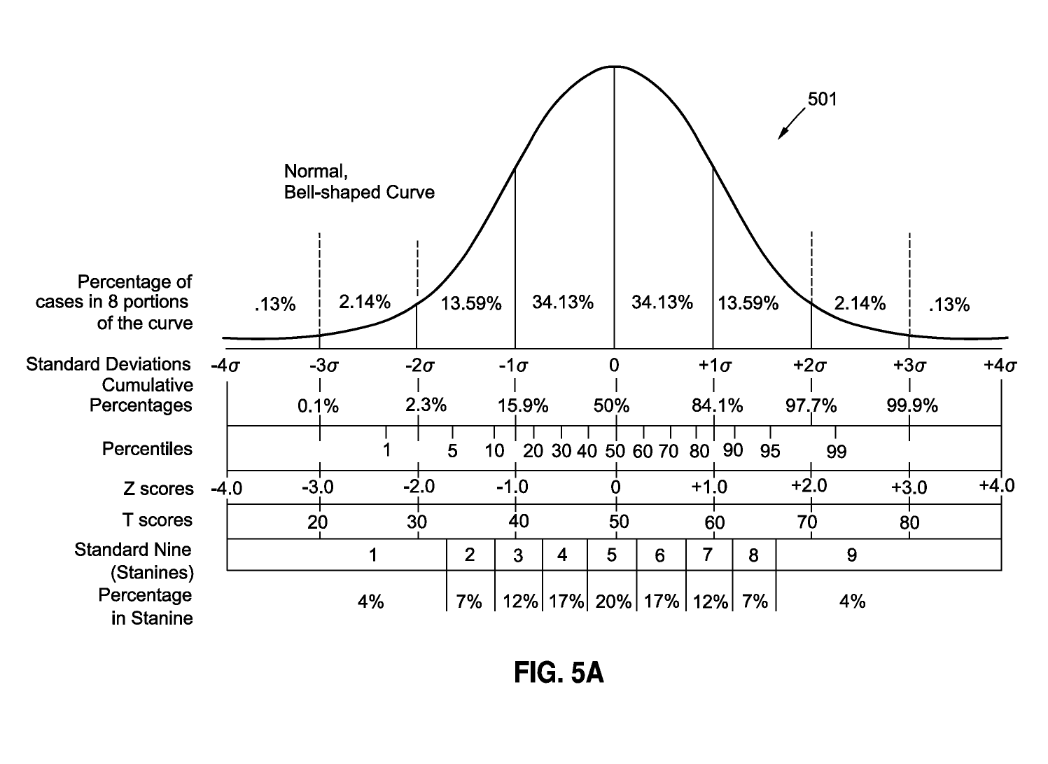

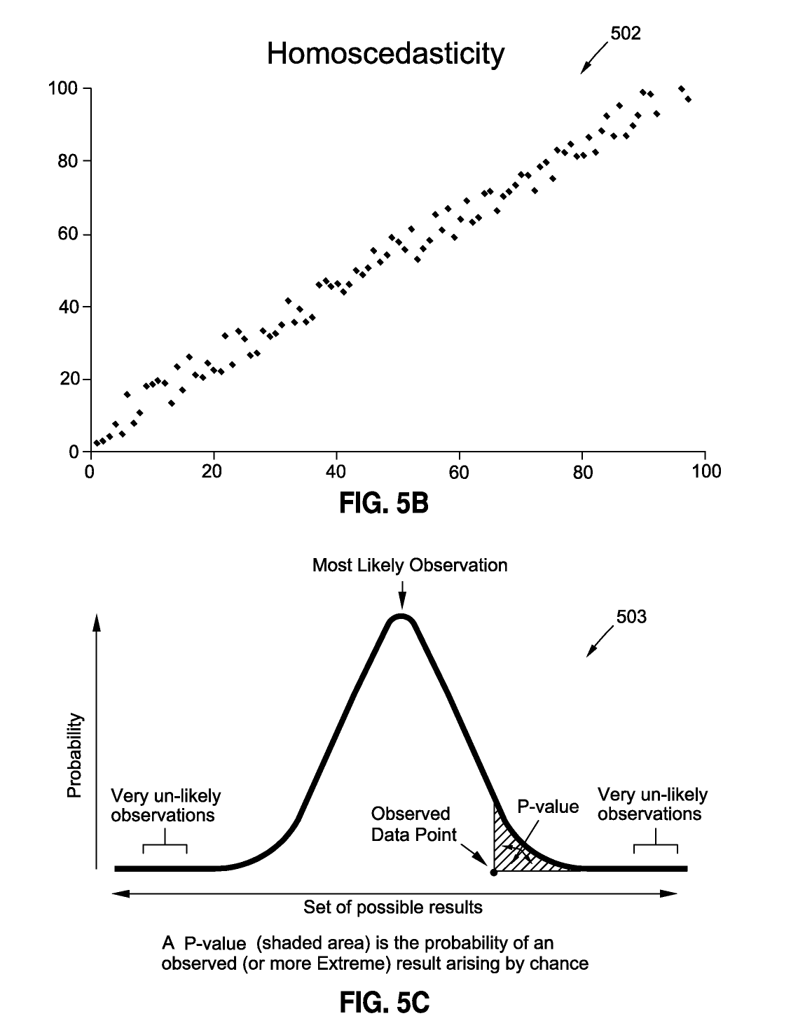

In that regard, a T-test is one of a number of tests for comparing two distributions of data, and yields a confidence level of similarity. Specifically, the p-value of the T-test indicates whether the distributions are similar. A homoscedastic T-test is a specific t-test which assumes an equal mean and equal variance, and is used to gauge whether two distributions are similar. Homoscedasticity is described more fully below with respect to FIG. 5C. As mentioned above, the T-test can be used to compare metrics of an incoming access request against existing profiles (companies, groups, etc.), and if the distributions are similar, the threshold for determining an anomaly can be modified to be closer to those of the existing profiles.

Thus, two distributions can be compared for similarity by using a threshold against the p-value of a T-test. The threshold could be predetermined, learned by user interaction, acquired by existing datasets, or dynamically determined. The p-value is compared against the threshold to formulate a conclusion. If the p-value does not meet certain conditions, the hypothesis that the two distributions are similar is rejected. A suitable threshold for the p-value should be determined so as to ascertain if the two distributions the T-test is comparing are similar for a given scenario.

The p-value of the T-test can also be used as the statistical measure for determining an anomaly (rather than just for adjusting the threshold therefor). For example, a respective p-value of the T-test can be calculated for (a) the metrics of the incoming access request and (b) metrics in another distribution corresponding to suspicious activity, and the resultant p-values can both be compared to a threshold.

In addition, more than one statistical measure may be used at once, such as, for example, comparing user metrics to see if all incoming user metrics are within “α” z-score (distance from mean in standard deviations) and p-value of at least β from a homoscedastic T-test. In that regard, “α” and “β” may be dynamically computed values based on contextual information associated with each user visit.

The T-test and p-value need not consider all of the metrics collected. Thus, in one example, the threshold for detecting an anomaly based on the statistical measure can be modified based on a distribution of one metric in the profile (e.g., access time). In another example, the threshold for detecting an anomaly based on the statistical measure can be modified based on a distribution of a subset of metrics in the profile. In still another example, the threshold for detecting an anomaly based on the statistical measure can be modified based on a distribution of all metrics in the profile.

Accordingly, a subset of the user's accesses (visits) is compared to known patterns from the profile over time. As mentioned above, such comparisons might be against patterns determined in a previous period of time (e.g., the last two weeks). For example, it could be determined whether the current week's activity resembles the previous week's activity, or whether two users have very similar activity for the last week. In another example, it can be determined whether all of the visits by users are very correlated, which might suggest a distributed denial of service attack (DDOS). In still another example, there might be a certain category/type of user that can be categorized based on their activity.

In step 404, there is a determination of whether the incoming access request is an anomaly based on the comparison.

In one embodiment, the threshold includes a predetermined statistical variation based on the statistical measure (e.g., a z-score of 2.0 standard deviations), and the incoming access request is determined to be an anomaly if one or more of the metrics differ from the profile by greater or less than the threshold. In another embodiment, the threshold includes a dynamically determined statistical variation based on the statistical measure (e.g., a z-score which changes based on the data), and the incoming access request is determined to be an anomaly if one or more of the metrics differ from the profile by greater or less than the threshold.

In another example mentioned above, each incoming request can be compared against the background user profile to see if all incoming user metrics are within “α” z-score (distance from mean in standard deviations) and/or p-value of at least β from a homoscedastic T-test. The request is determined to be an anomaly if the above conditions are not met.

If it is determined that the incoming access request is not an anomaly, the process proceeds to step 405 to allow access by the incoming access request.

On the other hand, if the incoming access request is determined to be an anomaly, the process proceeds to step 406 to deny the access and/or increase security (e.g., for subsequent requests). For example, if the incoming access request is determined to be an anomaly, the incoming access request may simply be denied. In another example, however, if the incoming access request is determined to be an anomaly, the incoming access request is allowed, with future requests from the associated user being subject to increased security.

In the latter example, “increased security” can reflect any number of actions. For example, the threshold for the z-score (or modified z-score), and/or the z-score or modified z-score itself can be changed for the user in order to be more strict. Thus, in one example, if the incoming access request is determined to be an anomaly, the threshold number of standard deviations in the z-score might be reduced from 2.0 to 1.8. Along the same lines, the distribution of metrics for that user's access going forward might be compared against a different group with stricter scrutiny (e.g., a group under suspicion), which might then cause a modification in the threshold for subsequent accesses. In another example, security might be increased by informing an administrator, who can then take further action.

In either case, the process then proceeds back to step 401 to continue collecting access metrics.

FIGS. 5A to 5C are views for explaining statistical measures according to an example embodiment.

In particular, FIG. 5A is an illustration for explaining the z-score in a normal distribution, which is a statistical measure which can be used to compare metrics of an incoming access request against the user profile.

FIG. 5B is an illustration for explaining the p-value. In statistical significance, testing the p-value is the probability of obtaining a test statistic at least as extreme as the one that was actually observed, assuming that the null hypothesis is true.

FIG. 5C is an illustration for explaining homoscedasticity, which is a statistical characteristic of a set of data. In particular, a sequence or a vector of random variables is homoscedastic, if all random variables in the sequence or vector have the same finite variance. Thus, FIG. 5C shows a plot with random data with homoscedasticity. In the context of the comparison of an incoming access request against the user profile, homoscedasticity can be used to accurately match time access patterns to profile user access time behavior. For example, homoscedasticity can be used as a metric to compare if two distributions are similar, and can be used in the T-test described above.

### Other Embodiments

According to other embodiments contemplated by the present disclosure, example embodiments may include a computer processor such as a single core or multi-core central processing unit (CPU) or micro-processing unit (MPU), which is constructed to realize the functionality described above. The computer processor might be incorporated in a stand-alone apparatus or in a multi-component apparatus, or might comprise multiple computer processors which are constructed to work together to realize such functionality. The computer processor or processors execute a computer-executable program (sometimes referred to as computer-executable instructions or computer-executable code) to perform some or all of the above-described functions. The computer-executable program may be pre-stored in the computer processor(s), or the computer processor(s) may be functionally connected for access to a non-transitory computer-readable storage medium on which the computer-executable program or program steps are stored. For these purposes, access to the non-transitory computer-readable storage medium may be a local access such as by access via a local memory bus structure, or may be a remote access such as by access via a wired or wireless network or Internet. The computer processor(s) may thereafter be operated to execute the computer-executable program or program steps to perform functions of the above-described embodiments.

According to still further embodiments contemplated by the present disclosure, example embodiments may include methods in which the functionality described above is performed by a computer processor such as a single core or multi-core central processing unit (CPU) or micro-processing unit (MPU). As explained above, the computer processor might be incorporated in a stand-alone apparatus or in a multi-component apparatus, or might comprise multiple computer processors which work together to perform such functionality. The computer processor or processors execute a computer-executable program (sometimes referred to as computer-executable instructions or computer-executable code) to perform some or all of the above-described functions. The computer-executable program may be pre-stored in the computer processor(s), or the computer processor(s) may be functionally connected for access to a non-transitory computer-readable storage medium on which the computer-executable program or program steps are stored. Access to the non-transitory computer-readable storage medium may form part of the method of the embodiment. For these purposes, access to the non-transitory computer-readable storage medium may be a local access such as by access via a local memory bus structure, or may be a remote access such as by access via a wired or wireless network or Internet. The computer processor(s) is/are thereafter operated to execute the computer-executable program or program steps to perform functions of the above-described embodiments.

The non-transitory computer-readable storage medium on which a computer-executable program or program steps are stored may be any of a wide variety of tangible storage devices which are constructed to retrievably store data, including, for example, any of a flexible disk (floppy disk), a hard disk, an optical disk, a magneto-optical disk, a compact disc (CD), a digital versatile disc (DVD), micro-drive, a read only memory (ROM), random access memory (RAM), erasable programmable read only memory (EPROM), electrically erasable programmable read only memory (EEPROM), dynamic random access memory (DRAM), video RAM (VRAM), a magnetic tape or card, optical card, nanosystem, molecular memory integrated circuit, redundant array of independent disks (RAID), a nonvolatile memory card, a flash memory device, a storage of distributed computing systems and the like. The storage medium may be a function expansion unit removably inserted in and/or remotely accessed by the apparatus or system for use with the computer processor(s).

This disclosure has provided a detailed description with respect to particular representative embodiments. It is understood that the scope of the appended claims is not limited to the above-described embodiments and that various changes and modifications may be made without departing from the scope of the claims.

What is claimed is:

1. A method for managing access to one or more web services, the method comprising:
collecting metrics associated with accesses to a service, wherein the metrics include activities associated with a user;
generating and updating a profile associated with the user;
comparing one or more metrics of an incoming access request to the service against the profile using a statistical measure and a corresponding threshold for detecting an anomaly, wherein the threshold is determined based on associations between a distribution of the metrics of the profile and a subset of other profile metric distributions; and
determining whether the incoming access request is an anomaly based on the comparison.

2. The method according to claim 1, wherein the threshold comprises a predetermined statistical variation based on the statistical measure, and wherein the incoming access request is determined to be an anomaly if one or more of the metrics differ from the profile by greater or less than the threshold.

3. The method according to claim 1, wherein the threshold comprises a dynamically determined statistical variation based on the statistical measure, and wherein the incoming access request is determined to be an anomaly if one or more of the metrics differ from the profile by greater or less than the threshold.

4. The method according to claim 1, wherein the threshold for detecting an anomaly based on the statistical measure is modified based on a distribution of metrics in the profile.

5. The method according to claim 4, wherein the threshold for detecting an anomaly based on the statistical measure is modified based on comparison of the distribution of metrics in the profile against a group profile representing a subset of past usage.

6. The method according to claim 5, wherein the distribution of metrics is compared against the group profile using a p-value of a T-test.

7. The method according to claim 1, wherein a respective p-value of the T-test is calculated for (a) the metrics of the incoming access request and (b) the metrics in the other distribution, and wherein the p-values are both compared to the threshold.

8. The method according to claim 1, wherein the statistical measure used in the comparison is a z-score.

9. The method according to claim 1, wherein the statistical measure used in the comparison is a modified z-score using a median absolute deviation (MAD).

10. The method according to claim 1, wherein multiple profiles are associated with a user, and wherein each of the profiles is compared against the incoming access request.

11. The method according to claim 10, wherein the multiple profiles include at least two of a global profile, a profile based on geographic information, a company profile, an IP profile, a user agent profile, and a user profile.

12. The method according to claim 1, wherein if the incoming access request is determined to be an anomaly, the incoming access request is denied.

13. The method according to claim 1, wherein if the incoming access request is determined to be an anomaly, the incoming access request is allowed, with future requests from the associated user being subject to increased security.

14. The method according to claim 1, wherein the profile is dynamically updated in real-time or pseudo-real-time based on the accesses.

15. The method according to claim 1, wherein the profile is updated after a set time period.

16. The method according to claim 1, wherein the profile is updated after a predetermined amount of data has been collected.

17. The method according to claim 1, wherein the metrics include one or more of IP address, geographic information, date and time of visit, URI access patterns, download patterns, browser type, operating system, operating system version, browser version, user agent, web-related metrics computed via an analytical engine or a prediction engine, and a device used to access.

18. The method according to claim 1, wherein the threshold for detecting an anomaly based on the statistical measure is modified based on a distribution of one metric in the profile.

19. The method according to claim 1, wherein the threshold for detecting an anomaly based on the statistical measure is modified based on a distribution of a subset of metrics in the profile.

20. The method according to claim 1, wherein the threshold for detecting an anomaly based on the statistical measure is modified based on a distribution of all metrics in the profile.

21. The method according to claim 1, wherein a period of time for collecting metrics associated with accesses is changed in accordance with the metrics collected.

22. The method according to claim 1, wherein a period of time for collecting metrics associated with accesses is changed in accordance with a user selection.

23. An apparatus for apparatus for managing access to one or more web services, comprising:
a computer-readable memory constructed to store computer-executable process steps; and
a processor constructed to execute the process steps stored in the memory, wherein the process steps cause the processor to:
collect metrics associated with accesses to a service, wherein the metrics include activities associated with a user;
generate and updating a profile associated with the user;
compare one or more metrics of an incoming access request to the service against the profile using a statistical measure and a corresponding threshold for detecting an anomaly, wherein the threshold is determined based on associations between a distribution of the metrics of the profile and a subset of other profile metric distributions; and
determine whether the incoming access request is an anomaly based on the comparison.

24. A non-transitory computer-readable storage medium storing computer-executable process steps for causing a computer to perform a method for managing access to one or more web services, the method comprising:
collecting metrics associated with accesses to a service, wherein the metrics include activities associated with a user;
generating and updating a profile associated with the user;
comparing one or more metrics of an incoming access request to the service against the profile using a statistical measure and a corresponding threshold for detecting an anomaly, wherein the threshold is determined based on associations between a distribution of the metrics of the profile and a subset of other profile metric distributions; and
determining whether the incoming access request is an anomaly based on the comparison.
